(19) United States
(12) Patent Application Publication
(10) Pub. No.: US 2026/0206020 A1
(43) Pub. Date: Jul. 16, 2026

(54) INDICATION FOR UNUSED TRANSMISSION OCCASIONS

(71) Applicant: Lenovo (Singapore) Pte. Limited, Singapore (SG)

(72) Inventors: Hossein Bagheri, Urbana, IL (US); Joachim Löhr, Wiesbaden (DE); Vijay Nangia, Woodridge, IL (US)

(73) Assignee: Lenovo (Singapore) Pte. Limited, Singapore (SG)

(21) Appl. No.: 19/134,701

(22) PCT Filed: Jan. 10, 2024
(86) PCT No.: PCT/IB2024/050261

§ 371 Date: May 30, 2025

Related U.S. Application Data
(60) Provisional application No. 63/479,524, filed on Jan. 11, 2023.

(51) Int. Cl. H04W 72/11; H04W 72/21; H04W 72/50

(52) U.S. Cl. CPC H04W 72/11; H04W 72/21; H04W 72/535

(57) ABSTRACT

Various aspects of the present disclosure relate to methods, apparatuses, and systems that support indication for unused transmission occasions. For instance, implementations provide for configuration of an indication of unused CG transmission occasions of one or more CG configurations, such as via UCI. Further, rules are provided for counting and ordering transmission occasions based on an indication of unused transmission occasions. Time-region based indications of unused transmission occasions are also described, as well as number-of-occasion based indications of unused transmission occasions.

### RELATED APPLICATION

This application claims priority to U.S. Provisional Application Ser. No. 63/479,524 filed 11 Jan. 2022 entitled “INDICATION FOR UNUSED TRANSMISSION OCCASIONS,” the disclosure of which is incorporated by reference herein in its entirety.

### TECHNICAL FIELD

The present disclosure relates to wireless communications, and more specifically to configuration of transmission resources in wireless communications.

### BACKGROUND

A wireless communications system may include one or multiple network communication devices, such as base stations, which may be otherwise known as an eNodeB (eNB), a next-generation NodeB (gNB), or other suitable terminology. Each network communication devices, such as a base station may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, sub-slots, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

Some wireless communications systems provide ways for providing transmission resources for a UE to transmit data, e.g., for uplink (UL) transmission. For instance, a network can allocate pre-configured resources also known as configured grant (CG) resources to a UE for UL transmission. A UE, however, may not utilize at least some CG resources, which may result in inefficient use of UL resources.

### SUMMARY

The present disclosure relates to methods, apparatuses, and systems that support indication for unused transmission occasions. For instance, implementations provide for configuration of an indication of unused CG transmission occasions of one or more CG configurations, such as via uplink control information (UCI). Further, rules are provided for counting and ordering transmission occasions based on an indication of unused transmission occasions. Time-region based indications of unused transmission occasions are also described, as well as number-of-occasion based indications of unused transmission occasions.

By utilizing the described techniques, a UE can notify a network of unused transmission occasions of allocated CG transmission occasions, which can enable the network to efficiently schedule transmissions (e.g., by the UE or other UEs) on CG resources. This can enable more efficient determination and scheduling of available CG resources.

Some implementations of the methods and apparatuses described herein may further include receiving a first set of CG configurations including a second set of CG configurations that are a subset of the first set of CG configurations, and a third set of CG configurations that are a subset of the second set of CG configurations; generating an indication of one or more unused transmission occasions of a list of transmission occasions, the transmission occasions of the list of transmission occasions occurring within a window of time and being ordered in an order of start time of the transmission occasions, and the one or more unused transmission occasions being associated with the second set of CG configurations; and transmitting, in a transmission occasion of the third set of CG configurations, the indication of the one or more unused transmission occasions.

Some implementations of the methods and apparatuses described herein may further include: the second set of CG configurations includes at least two CG configurations; where a CG configuration of the first set of CG configurations enables UL transmissions in periodic UL resources with a configured periodicity associated with the CG configuration, and an UL resource of the UL resources belongs to a period of a plurality of periods; identifying, in the indication of the one or more unused transmission occasions, the one or more unused transmission occasions as one or more transmission occasions in which no CG-physical uplink shared channel (PUSCH) transmission is to occur; transmitting the indication of the one or more unused transmission occasions via UCI; transmitting, the UCI in a transmission occasion, and the transmission occasion is associated with a first CG configuration of the third set of CG configurations; determining a duration of the window of time based at least in part on at least one of a higher layer configuration message, a periodicity of the first CG configuration, a time location of the UCI, a frequency location of the UCI, an end of the UCI, or a number of bits configured for indication of the one or more unused transmission occasions in the UCI; determining the second set of CG configurations based at least in part on an indication indicating CG configuration indices of a fourth set of CG configurations, where the fourth set of CG configurations includes at least CG configurations of the second set of CG configurations excluding the first CG configuration.

Some implementations of the methods and apparatuses described herein may further include: receiving downlink control information (DCI) activating the first CG configuration, and transmitting the UCI based at least in part on the DCI indicating that the UCI is permitted to be sent in a transmission occasion associated with the first CG configuration; the DCI activating the first CG configuration indicates at least one of a number of bits in the UCI for indication of the one or more unused transmission occasions and a duration of the window of time; determining a duration of the window of time based at least in part on higher layer signaling; receiving an indication indicating a fourth set of CG configurations, and determining the second set of CG configurations by excluding the fourth set of CG configurations from the first set of CG configurations; transmitting the indication of the one more unused transmission occasions via UCI, and generating the UCI to indicate, for the one or more unused transmission occasions: a first set of unused transmission occasions associated with a first group of CG configurations in a first field in the UCI; and a second set of unused transmission occasions associated with a second group of CG configurations in a second field in the UCI, where a position of the first field and a position of the second field within the UCI are configured, and the first group of CG configurations and the second group of CG configurations do not share a common CG configuration.

Some implementations of the methods and apparatuses described herein may further include: determining the list of transmission occasions in an order of a respective start time of each transmission occasion within the window of time; determining the list of transmission occasions such that a first transmission occasion of the list of transmission occasions has an earliest start time of the transmission occasions, and subsequent transmission occasions after the first transmission occasion are identified in the list of transmission occasions in a corresponding temporal order; where if a first transmission occasion and a second transmission occasion have a same start time, determining the first transmission occasion as earlier than the second transmission occasion in the list of transmission occasions based at least in part on one or more of: the first transmission occasion ending earlier than the second transmission occasion; the first transmission occasion including fewer resource elements than the second transmission occasion; the first transmission occasion being associated with a higher priority than the second transmission occasion; the first transmission occasion being associated with a lower latency than the second transmission occasion; the first transmission occasion starting in a frequency domain earlier than the second transmission occasion; or the first transmission occasion being associated with a smaller CG configuration index than the second transmission occasion.

Some implementations of the methods and apparatuses (e.g., a network) described herein may further include: generating a CG indication including a first set of CG configurations, a second set of CG configurations that are a subset of the first set of CG configurations, and a third set of CG configurations that are subset of the second set of CG configurations; transmitting the CG indication and receiving, in a transmission occasion of the third set of CG configurations, an indication of one or more unused transmission occasions of a list of transmission occasions, the transmission occasions of the list of transmission occasions occurring within a window of time and being ordered in an order of start time of transmission occasions.

Some implementations of the methods and apparatuses (e.g., a network) described herein may further include: a CG configuration of the first set of CG configurations enables UL transmissions in periodic UL resources with a configured periodicity associated with the CG configuration, and an UL resource of the UL resources belongs to a period of a plurality of periods; receiving the indication of the one or more unused transmission occasions via UCI; determining the one or more unused transmission occasions from the indication of the one or more unused transmission occasions based at least in part on the list of transmission occasions and the UCI; indicating a duration of the window of time via higher layer signaling; transmitting an indication of a fourth set of CG configurations for which an apparatus does not expect to receive the indication of the one or more unused transmission occasions; generating the list of transmission occasions in an order of a respective start time of each transmission occasion within the window of time.

Some implementations of the methods and apparatuses described herein may further include: if a first transmission occasion and a second transmission occasion have a same start time, determine the first transmission occasion as earlier than the second transmission occasion in the list of transmission occasions based at least in part on one or more of: the first transmission occasion ending earlier than the second transmission occasion; the first transmission occasion including fewer resource elements than the second transmission occasion; the first transmission occasion being associated with a higher priority than the second transmission occasion; the first transmission occasion being associated with a lower latency than the second transmission occasion; the first transmission occasion starting earlier in a frequency domain earlier than the second transmission occasion; or the first transmission occasion being associated with a smaller CG configuration index than the second transmission occasion.

### BRIEF DESCRIPTION OF THE DRAWINGS

FIG. 1 illustrates an example of a wireless communications system that supports indication for unused transmission occasions in accordance with aspects of the present disclosure.

FIG. 2 illustrates an example scenario for UCI indicating unused PUSCH occasions.

FIG. 3 illustrates an example scenario for indicating unused CGs in a period.

FIG. 4 illustrates an example implementation scenario that supports indication for unused transmission occasions by grouping CG configurations for the purpose of indication of unused transmission occasions in accordance with aspects of the present disclosure.

FIG. 5 illustrates an example implementation scenario that supports indication for unused transmission occasions in accordance with aspects of the present disclosure.

FIG. 6 illustrates an example implementation scenario that supports indication for unused transmission occasions in accordance with aspects of the present disclosure.

FIG. 7 illustrates an example implementation scenario that supports indication for unused transmission occasions in accordance with aspects of the present disclosure.

FIG. 8 illustrates an example implementation scenario that supports indication for unused transmission occasions in accordance with aspects of the present disclosure.

FIG. 9 illustrates an example implementation scenario that supports indication for unused transmission occasions in accordance with aspects of the present disclosure.

FIGS. 10 and 11 illustrate examples of block diagrams of devices that support indication for unused transmission occasions in accordance with aspects of the present disclosure.

FIGS. 12 and 13 illustrate flowcharts of methods that support indication for unused transmission occasions in accordance with aspects of the present disclosure.

### DETAILED DESCRIPTION

In wireless communications systems, a UE can be configured by a network entity with multiple CG configurations for UL transmission. Further, UCI multiplexed with an UL transmission associated with a CG configuration can indicate unused CG transmission occasions which can belong to the same or different CG configuration in which the UCI is sent. Current ways for indicating unused CG transmission occasions, however, may be inefficient and not account for variations in arrangement of unused CG transmission occasions.

Accordingly, the present disclosure relates to methods, apparatuses, and systems that support indication for unused transmission occasions. For instance, implementations provide for configuration of an indication of unused CG transmission occasions of one or more CG configurations, such as via UCI. Further, rules are provided for counting and ordering transmission occasions to be used for an indication of unused transmission occasions amongst the counted and ordered transmission occasions. Time-region based indications of unused transmission occasions are also described, as well as number-of-occasion based indications of unused transmission occasions.

By utilizing the described techniques, a UE can notify a network of unused transmission occasions of allocated CG transmission occasions, which can enable the network to efficiently schedule CG resources, e.g., for the UE or for other UEs. Some benefits of enabling a UE to indicate unused transmission occasions of multiple CG configurations as opposed to those of single CG configuration include providing a gNB with an indication of available resources of multiple CG configurations in a more expedient manner which can enable more accurate scheduling decisions, as well as less frequent UCI multiplexed in PUSCH occasions.

Aspects of the present disclosure are described in the context of a wireless communications system. Aspects of the present disclosure are further illustrated and described with reference to device diagrams and flowcharts.

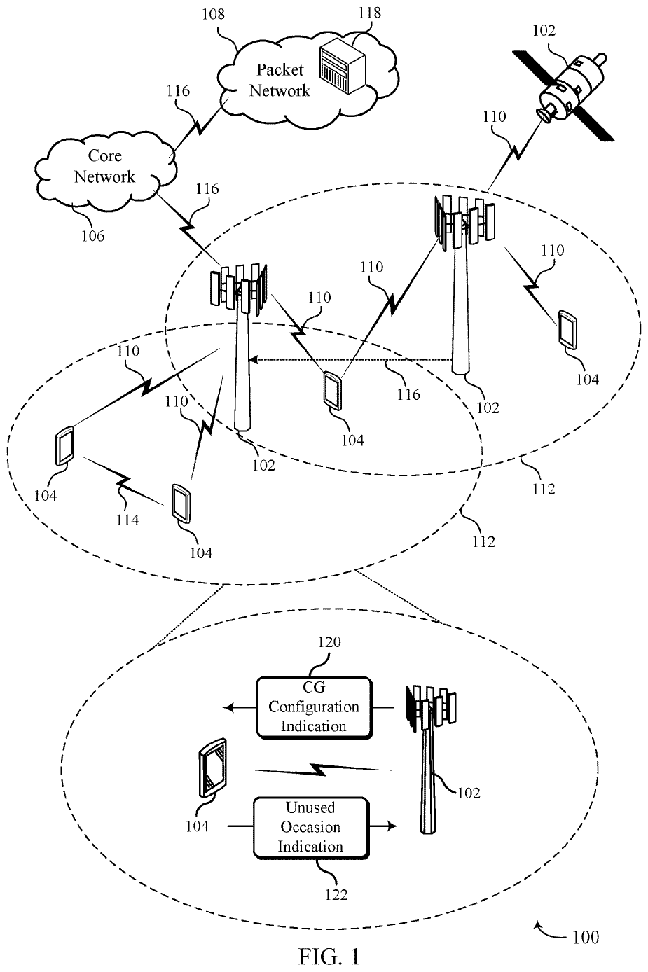

FIG. 1 illustrates an example of a wireless communications system 100 that supports indication for unused transmission occasions in accordance with aspects of the present disclosure. The wireless communications system 100 may include one or more network entities 102, one or more UEs 104, a core network 106, and a packet data network 108. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as an NR network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more network entities 102 may be dispersed throughout a geographic region to form the wireless communications system 100. One or more of the network entities 102 described herein may be or include or may be referred to as a network node, a base station, a network element, a radio access network (RAN), a base transceiver station, an access point, a NodeB, an eNodeB (eNB), a next-generation NodeB (gNB), or other suitable terminology. A network entity 102 and a UE 104 may communicate via a communication link 110, which may be a wireless or wired connection. For example, a network entity 102 and a UE 104 may perform wireless communication (e.g., receive signaling, transmit signaling) over a Uu interface.

A network entity 102 may provide a geographic coverage area 112 for which the network entity 102 may support services (e.g., voice, video, packet data, messaging, broadcast, etc.) for one or more UEs 104 within the geographic coverage area 112. For example, a network entity 102 and a UE 104 may support wireless communication of signals related to services (e.g., voice, video, packet data, messaging, broadcast, etc.) according to one or multiple radio access technologies. In some implementations, a network entity 102 may be moveable, for example, a satellite associated with a non-terrestrial network. In some implementations, different geographic coverage areas 112 associated with the same or different radio access technologies may overlap, but the different geographic coverage areas 112 may be associated with different network entities 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region of the wireless communications system 100. A UE 104 may include or may be referred to as a mobile device, a wireless device, a remote device, a remote unit, a handheld device, or a subscriber device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. Some examples of UEs 104 are illustrated in FIG. 1. A UE 104 may be capable of communicating with various types of devices, such as the network entities 102, other UEs 104, or network equipment (e.g., the core network 106, the packet data network 108, a relay device, an integrated access and backhaul (IAB) node, or another network equipment), as shown in FIG. 1. Additionally, or alternatively, a UE 104 may support communication with other network entities 102 or UEs 104, which may act as relays in the wireless communications system 100.

A UE 104 may also be able to support wireless communication directly with other UEs 104 over a communication link 114. For example, a UE 104 may support wireless communication directly with another UE 104 over a device-to-device (D2D) communication link. In some implementations, such as vehicle-to-vehicle (V2V) deployments, V2X deployments, or cellular-V2X deployments, the communication link 114 may be referred to as a sidelink. For example, a UE 104 may support wireless communication directly with another UE 104 over a PC5 interface.

A network entity 102 may support communications with the core network 106, or with another network entity 102, or both. For example, a network entity 102 may interface with the core network 106 through one or more backhaul links 116 (e.g., via an S1, N2, N2, or another network interface). The network entities 102 may communicate with each other over the backhaul links 116 (e.g., via an X2, Xn, or another network interface). In some implementations, the network entities 102 may communicate with each other directly (e.g., between the network entities 102). In some other implementations, the network entities 102 may communicate with each other or indirectly (e.g., via the core network 106). In some implementations, one or more network entities 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

In some implementations, a network entity 102 may be configured in a disaggregated architecture, which may be configured to utilize a protocol stack physically or logically distributed among two or more network entities 102, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 102 may include one or more of a central unit (CU), a distributed unit (DU), a radio unit (RU), a RAN Intelligent Controller (RIC) (e.g., a Near-Real Time RIC (Near-real time (RT) RIC), a Non-Real Time RIC (Non-RT RIC)), a Service Management and Orchestration (SMO) system, or any combination thereof.

An RU may also be referred to as a radio head, a smart radio head, a remote radio head (RRH), a remote radio unit (RRU), or a transmission reception point (TRP). One or more components of the network entities 102 in a disaggregated RAN architecture may be co-located, or one or more components of the network entities 102 may be located in distributed locations (e.g., separate physical locations). In some implementations, one or more network entities 102 of a disaggregated RAN architecture may be implemented as virtual units (e.g., a virtual CU (VCU), a virtual DU (VDU), a virtual RU (VRU)).

Split of functionality between a CU, a DU, and an RU may be flexible and may support different functionalities depending upon which functions (e.g., network layer functions, protocol layer functions, baseband functions, radio frequency functions, and any combinations thereof) are performed at a CU, a DU, or an RU. For example, a functional split of a protocol stack may be employed between a CU and a DU such that the CU may support one or more layers of the protocol stack and the DU may support one or more different layers of the protocol stack. In some implementations, the CU may host upper protocol layer (e.g., a layer 3(L3 ), a layer 2 (L2)) functionality and signaling (e.g., radio resource control (RRC), service data adaption protocol (SDAP), Packet Data Convergence Protocol (PDCP)). The CU may be connected to one or more DUs or RUs, and the one or more DUs or RUs may host lower protocol layers, such as a layer 1(L1 ) (e.g., physical (PHY) layer) or an L2 (e.g., radio link control (RLC) layer, medium access control (MAC) layer) functionality and signaling, and may each be at least partially controlled by the CU.

Additionally, or alternatively, a functional split of the protocol stack may be employed between a DU and an RU such that the DU may support one or more layers of the protocol stack and the RU may support one or more different layers of the protocol stack. The DU may support one or multiple different cells (e.g., via one or more RUs). In some implementations, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU).

A CU may be functionally split further into CU control plane (CU-CP) and CU user plane (CU-UP) functions. A CU may be connected to one or more DUs via a midhaul communication link (e.g., F1, F1-c, F1-u), and a DU may be connected to one or more RUs via a fronthaul communication link (e.g., open fronthaul (FH) interface). In some implementations, a midhaul communication link or a fronthaul communication link may be implemented in accordance with an interface (e.g., a channel) between layers of a protocol stack supported by respective network entities 102 that are in communication via such communication links.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more network entities 102 associated with the core network 106.

The core network 106 may communicate with the packet data network 108 over one or more backhaul links 116 (e.g., via an S1, N2, N2, or another network interface). The packet data network 108 may include an application server 118. In some implementations, one or more UEs 104 may communicate with the application server 118. A UE 104 may establish a session (e.g., a PDU session, or the like) with the core network 106 via a network entity 102. The core network 106 may route traffic (e.g., control information, data, and the like) between the UE 104 and the application server 118 using the established session (e.g., the established PDU session). The PDU session may be an example of a logical connection between the UE 104 and the core network 106 (e.g., one or more network functions of the core network 106).

In the wireless communications system 100, the network entities 102 and the UEs 104 may use resources of the wireless communication system 100 (e.g., time resources (e.g., symbols, slots, subframes, frames, or the like) or frequency resources (e.g., subcarriers, carriers) to perform various operations (e.g., wireless communications). In some implementations, the network entities 102 and the UEs 104 may support different resource structures. For example, the network entities 102 and the UEs 104 may support different frame structures. In some implementations, such as in 4G, the network entities 102 and the UEs 104 may support a single frame structure. In some other implementations, such as in 5G and among other suitable radio access technologies, the network entities 102 and the UEs 104 may support various frame structures (e.g., multiple frame structures). The network entities 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. The first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. Each slot may include a number (e.g., quantity) of symbols (e.g., orthogonal frequency-division multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the network entities 102 and the UEs 104 may perform wireless communications over one or more of the operating frequency bands. In some implementations, FR1 may be used by the network entities 102 and the UEs 104, among other equipment or devices for cellular communications traffic (e.g., control information, data). In some implementations, FR2 may be used by the network entities 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

According to implementations for indication for unused transmission occasions, a network entity 102 generates a CG configuration indication 120 and transmits the CG configuration indication 120 to a UE 104. The CG configuration indication 120, for instance, identifies CG resources that are usable by the UE 104 for UL transmission, such as UL transmission from the UE 104 to the network entity 102. The UE 104 receives the CG configuration indication 120, determines which CG resources identified by the CG configuration indication 120 are unused by the UE 104, and generates an unused occasion indication 122 that identifies transmission occasions of the CG resources that are unused by the UE 104. Different ways for generating and configuring the unused occasion indication 122 are described throughout this disclosure. In at least one implementation the unused occasion indication 122 is implemented via UCI. In another implementation, the unused occasion indication 122 is implemented via MAC-CE. The UE 104 transmits the unused occasion indication 122 to the network entity 102. In implementations the network entity 102 may utilize unused transmission occasions identified in the unused transmission indication 122 for scheduling uplink resources, such as to other UEs 104.

In some wireless communications systems, for CG scenarios, UL data transmission (e.g., PUSCH) may be scheduled with DCI on physical downlink control channel (PDCCH), or a semi-static configured grant may be provided over RRC, where two types of operation are supported:
The first PUSCH is triggered with a DCI, with subsequent PUSCH transmissions following the RRC configuration and scheduling received on the DCI, or
The PUSCH is triggered by data arrival to the UE's transmit buffer and the PUSCH transmissions follow the RRC configuration.

For CG operation with shared spectrum channel access, a CG-UCI (Configured Grant Uplink Control Information) can be transmitted in PUSCH scheduled by configured uplink grant.

Considering multiple occasions within a CG period, large video frame sizes may utilize more than one PUSCH occasion to be transmitted. For instance, 1-5 PUSCHs per video frame may be used depending on the channel condition and the video frame size. One way is to configure multiple PUSCH occasions within a CG period. Such an approach can be supported for shared spectrum as below:

Technical specification (TS) 38.214 Clause 6.1.2.3 specifies that for resource allocation for uplink transmission with configured grant: . . . A set of allowed periodicities P are defined in TS 38.331. The higher layer parameter cg-nrofSlots, provides the number of consecutive slots allocated within a configured grant period. The higher layer parameter cg-nrofPUSCH-InSlot provides the number of consecutive PUSCH allocations within a slot, where the first PUSCH allocation follows the higher layer parameter timeDomainAllocation for Type 1 PUSCH transmission or the higher layer configuration according to TS 38.321, and UL grant received on the DCI for Type 2 PUSCH transmissions, and the remaining PUSCH allocations have the same length and PUSCH mapping type, and are appended following the previous allocations without any gaps. The same combination of start symbol and length and PUSCH mapping type repeats over the consecutively allocated slots.

In some scenarios, a CG resource is semi-statically configured and thus may have difficulty adapting to the varying size of video frames, such as the ones associated with extended reality such as virtual reality and or augmented reality. If the number of configured resources is not sufficient for transmission of a video frame, some scheduling delay associated with the dynamic scheduling could occur for scheduling the rest of the video frame that could not be fit in the configured resources.

To avoid the extra delay caused by additional dynamic scheduling, the CG resource within one CG period can be configured according to a relatively large size for transmission of a video frame. Upon arrival of the video frame at UE's buffer, the UE can determine how much resource out of the configured resources within one CG period is to be used and can indicate the unused number of resources to gNB so that gNB can schedule other UL transmissions (e.g., for the same UE or a different UE) in at least some of the unused resources, such as transmission occasions and/or time-domain resources. The indication can be via UCI or MAC control element (CE) and can be transmitted in the first CG PUSCH occasion. Note that the indication can potentially indicate unused CG occasions and/or resources associated with multiple configured configurations, e.g., in one CG period or in multiple CG periods.

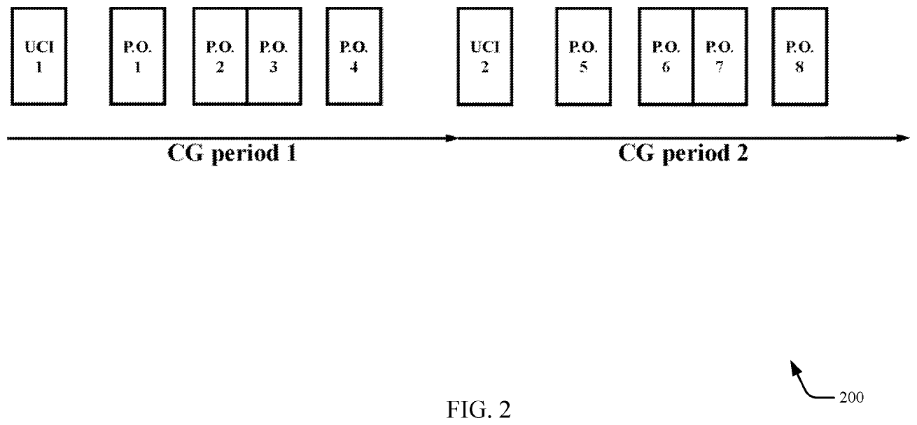

FIG. 2 illustrates an example scenario 200 for UCI indicating unused PUSCH occasions. For instance, a UCI in a CG transmission occasion of a CG configuration can be used to indicate unused transmission occasions of the CG configuration within one period of the CG configuration, such as illustrated in the scenario 200. The scenario 200, for example, illustrates UCI indicating 4 unused PUSCH occasions. In a first UCI within CG period 1, a UE can indicate unused PUSCH occasions P.O.3 and P.O.4 out of P.O.1-P.O.4, whereas in a second UCI within CG period 2 the UE can indicate unused PUSCH occasions P.O.6, P.O.7, and P.O.8 out of P.O.5-P.O.8 In contrast, this disclosure provides ways for indicating unused transmission occasions of multiple CG configurations by a UCI.

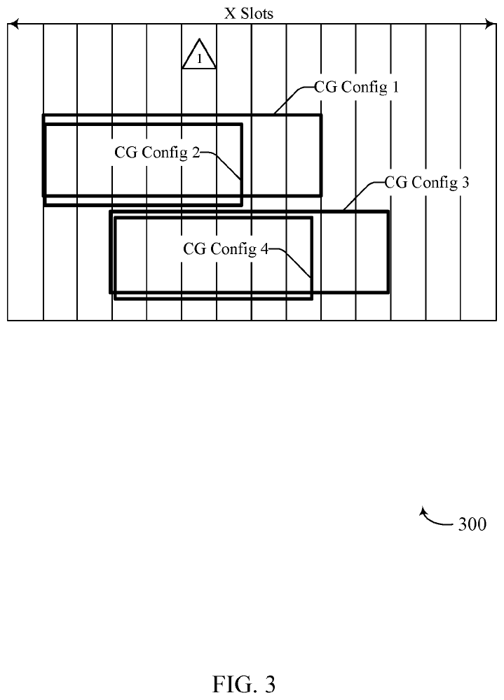

FIG. 3 illustrates an example scenario 300 for indicating unused CGs in a period. In the scenario 300, for instance, an indication in a physical uplink control channel (PUCCH) resource 1/CG-UCI indicates if a transport block (TB) transmission occurs in 1^{st}, 2^{nd}, 3^{rd}, and 4^{th} CG configuration. For example, alternatively to a CG configuration with multiple PUSCH occasions within a period, multiple CG configurations each providing one PUSCH occasion can be used to accommodate varying packet size (e.g., from one video frame to another video frame) by selecting one of the CG configurations to transmit a video frame. A CG-UCI in one of the CG configurations can indicate which CG configuration is used in a time window, e.g., when the CGs used for UL transmission of an extended reality (XR) packet have the same periodicity but different resource duration in time domain. For instance, a UCI in a PUSCH occasion of one of the CGs can indicate which CGs are unused in a period, e.g., CG2 is used, and CG1, CG3, and CG4 have unused PUSCH occasions as illustrated in the scenario 300. Accordingly, this disclosure provides additional details for such implementations, e.g., details of UCI indication, rules when CG configurations overlap in time domain, etc.

Accordingly, solutions are provided in this disclosure for indication for unused transmission occasions. For purposes of discussion throughout this disclosure, the terms CG transmission occasions, CG resources, and PUSCH occasions can be used interchangeably.

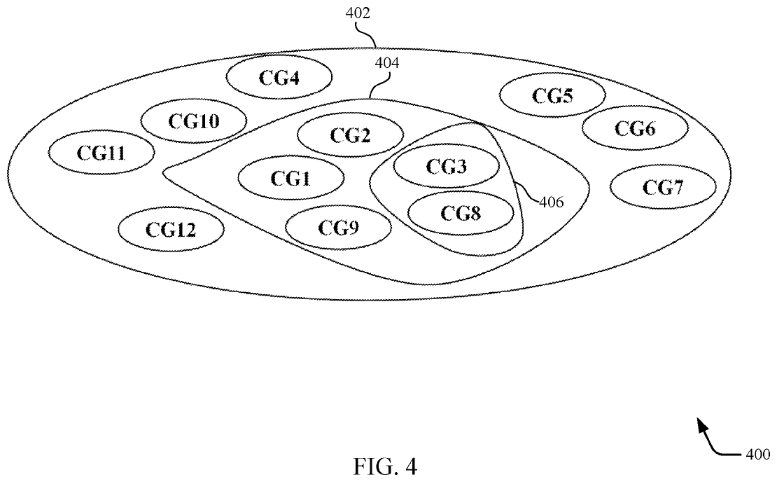

FIG. 4 illustrates an example implementation scenario 400 that supports indication for unused transmission occasions by grouping CG configurations for the purpose of indication of unused transmission occasions in accordance with aspects of the present disclosure. In the scenario 400, a UE is configured with a first set 402 of CG configurations for UL transmissions. The UE determines a second set 404 of CG configurations, where the second set 404 is a subset of the first set 402. The UE can indicate in a UCI of a third set 406 of CG configurations unused transmission occasions of the second set 404 of CG configurations, where the third set 406 is a subset of the second set 404. In the scenario 400, a UCI in CG 3 and/or CG 8 resources can indicate unused PUSCH occasions of CG 1, CG 2, CG 3, CG 8, and CG 9.

In implementations, CG configurations of the second set 404 of CG configurations belong to the same UL component carrier (CC) and/or bandwidth part (BWP). For instance, the second set 404 is configured via higher layer signaling (e.g., RRC). The indices of the CG configurations of the second set 404 of CG configurations, for example, are indicated by RRC. In implementations, and associated with each CG configuration (e.g., CG 1), in the third set 406 of CG configurations a list of CG configurations can be implemented which a UCI in the CG (e.g., CG 1) can indicate unused transmission occasions of the list of CG configurations. Alternatively or additionally, for each CG configuration (e.g., CG 2), the network can indicate (e.g., via RRC) which CG configurations can indicate unused transmission occasions of the CG configuration, e.g., CG 2.

According to implementations the second set 404 can be determined based on UCI indicating unused occasions. For instance, the UCI can indicate up to X number of successive, consecutive, and/or next transmission occasions from a reference time to be unused. In such implementations, such as depending on when the UCI is sent, the cardinality of the second set 404 of CG configurations can be different: For instance, if some CG configurations contain more than one CG PUSCH/transmission occasions or if the periodicity of some CG configurations of the first set of CG configurations are different.

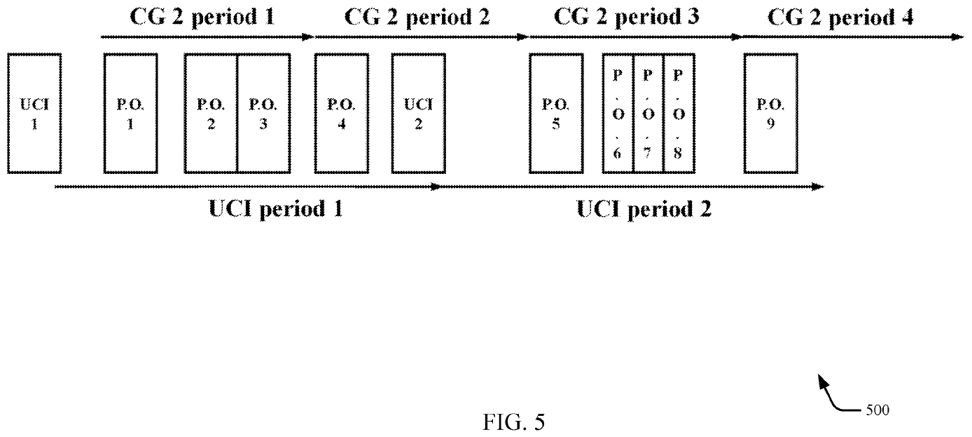

FIG. 5 illustrates an example implementation scenario 500 that supports indication for unused transmission occasions in accordance with aspects of the present disclosure. In the scenario 500, for instance, UCI can indicate up to 4 unused PUSCH occasions. In UCI period 1, for instance, a UE can indicate unused PUSCH occasions of CG 2, CG 3, and CG 4 (the cardinality of the second set of CG configurations is 3 in this UCI period); in UCI period 2, the UE can indicate unused PUSCH occasions of CG 2 and CG 5, e.g., the cardinality of the second set of CG configurations is 2 in the UCI period 2. In at least some implementations in the UCI period 2, the UE can indicate PUSCH occasions 5-7 as unused and not PUSCH occasion 8 in UCI 2.

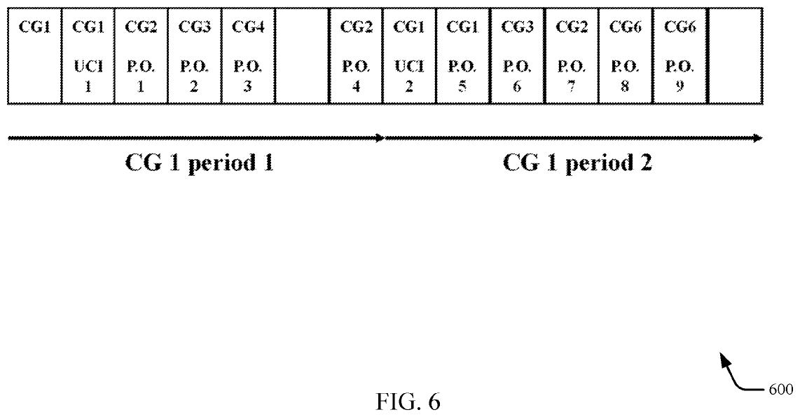

FIG. 6 illustrates an example implementation scenario 600 that supports indication for unused transmission occasions in accordance with aspects of the present disclosure. The scenario 600, for example, includes UCI indicating up to 4 unused PUSCH occasions. In a first CG 1 period 1, a UE can indicate unused PUSCH occasions of CG 2, CG 3, and CG 4, e.g., the cardinality of the second set of CG configurations is 3 in CG 1 period 1; in CG 1 period 2, the UE can indicate unused PUSCH occasions of CG 1, CG 5, CG 2, and CG 6, where the cardinality of the second set of CG configurations is 4 in the CG 1 period 2.

In implementations, the cardinality and/or the maximum cardinality of the second set of CG configurations can be reported to the network via a UE capability report signaling. Further, the third set of CG configurations can be configured via higher layer signaling, and the network can enable UCI indication of unused transmission occasions of the second set of CG configurations by CG configuration A, e.g., via DCI activating CG configuration ‘A’ from the third set of CG configurations.

In implementations, the CG configurations of the third set of CG configurations belong to a same UL CC/BWP. Alternatively, the third set is composed of one CG configuration per UL carrier or BWP and can include a reference CG configuration, where the rest of the CG configurations of the third set of CG configurations can be determined based on the reference CG configuration.

In implementations, the third set of CG configurations includes the next ‘m’ CG configurations after the reference CG configuration, where ‘m’ is configured or indicated by a MAC-CE or a DCI (such as a CG activation DCI); or the third set of CG configurations includes only the reference CG configuration.

In implementations the reference CG configuration index can be indicated by higher layer signaling (e.g., MAC-CE or RRC signaling) and/or by dynamic signaling (e.g., via DCI activating or deactivating a CG configuration) to the UE. When the network activates a CG configuration, the network can indicate (e.g., via the activation DCI for the CG configuration) to the UE whether the CG carrying the UCI to indicate unused PUSCH occasions is to be switched to the newly activated CG configuration (e.g., whether UCI indicating unused transmission occasions is to be sent on the newly activated CG configuration instead of the CG configuration where the UCI is previously being transmitted on). The network upon deactivating a CG configuration ‘A’ which is used to carry UCI indicating unused CG occasions of a set of CG configurations can indicate a CG index of another CG configuration to carry UCI indicating unused CG occasions. Further, each CG configuration of the third set can include more than one transmission occasion within one period of a respective CG configuration.

In implementations where a CG configuration of the third set of CG configurations includes multiple CG PUSCH occasions within a CG period, the UCI can be transmitted in a set of configured and/or determined locations. For instance, the UE is not expected to be configured with transmission of UCI indicating unused CG occasions within a CG that includes only a single occasion in a CG period. The UCI locations, for example, can be determined based on the number of CG occasions configured for the configured grant configuration, in which the UCI is sent.

In implementations, a UCI can indicate unused POs that are at least ‘y’ symbols after the end of the UCI transmission, such as illustrated in FIG. 6 and discussed below. A UCI can indicate unused PUSCH occasions associated with CG configurations corresponding to a low priority (e.g., priority 0) and/or non-latency critical UL transmissions. A UE may not be expected to indicate unused PUSCH occasions of a CG configuration associated with high priority or low latency.

In considering rules for counting and ordering transmission occasions, a list of transmission occasions (e.g., for indication of unused transmission occasions) can be constructed in the order of the start time of transmission occasions of multiple CG configurations. For instance, if a first transmission occasion (e.g., of a first CG configuration) and a second transmission occasion (e.g., of a second CG configuration) start at the same time, the transmission occasion from the two transmission occasions that ends earlier, contains less resource elements, is associated with a higher priority, is associated with a lower latency, starts in frequency domain earlier, is associated with a smaller CG configuration index, etc., can be determined, ordered, and/or considered as a transmission occasion that is earlier (or alternatively, later) in the candidate list of transmission occasions for indication of unused transmission occasions than the other transmission occasion.

In implementations, CG transmission occasions colliding with downlink (DL) symbols (e.g., symbols for reception of synchronization signal/physical broadcast channel (SS/PBCH) blocks and DL symbols indicated by tdd-UL-DL-ConfigurationCommon or symbols allocated for measurements according to a measurement gap configuration) may not be included in the candidate list of transmission occasions, e.g., for indication of unused transmission occasions.

In considering time-region-based indication of unused occasions, aspects of the following discussion can apply to scenarios where a) a UCI indicates unused CG transmission occasions belonging to single CG configuration and b) a UCI indicates unused CG transmission occasions belonging to multiple CG configurations. For instance, in implementations a UE can transmit a UCI in a CG transmission occasion associated with a first configured grant configuration, where the UCI indicates unused transmission occasions of a second set of CG configurations within a determined time region.

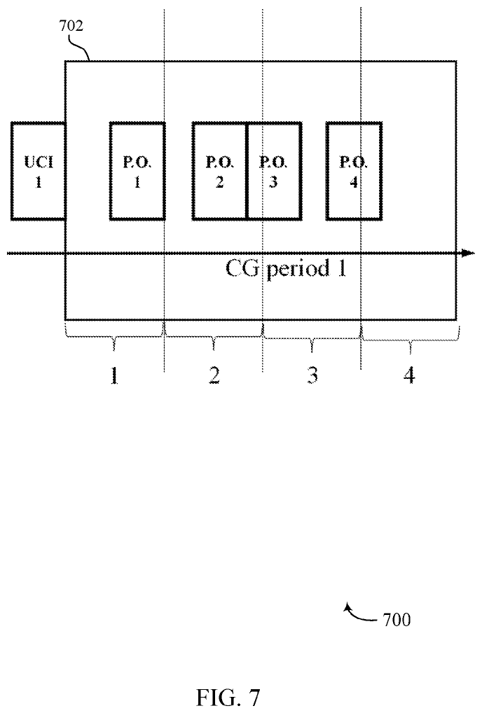

FIG. 7 illustrates an example implementation scenario 700 that supports indication for unused transmission occasions in accordance with aspects of the present disclosure. In the scenario 700 a time-region-based indication of unused transmission occasions in each CG period (e.g., where the UCI is sent) is illustrated. A time region 702 is illustrated that includes 4 groups of symbols. Further, P.O. 3 and P.O.4 are unused. In the time-region-based indication, time-groups 3 and 4 are indicated as unused. A UE, for instance, determines that P.O.3 and P.O. 4 are unused. Alternatively in another implementation, the UE determines P.O. 4 is only unused as a portion (beginning portion) of P.O. 3 belongs to the 2^{nd} group of symbols, and time group 2 is indicated as used.

In implementations, a second set of CG configurations at least includes a first CG configuration. Further, a time region can be configured via higher layer signaling such as RRC signaling for the first CG configuration, such as in units of ms, slots, or symbols corresponding to a reference subcarrier spacing (SCS).

Alternatively or additionally, a time region can be determined based on a periodicity of the first CG configuration, a UE reported capability (e.g., corresponding to a logical channel and/or a first CG configuration), and/or a number of bits of a field in the UCI indicating unused transmission occasions. For instance if the UCI field has 2 bits, then up to 4 transmission occasions can be indicated unused. If the first CG configuration has 2 PUSCH transmission occasions in each period of the 1st CG configuration, the time region can cover CG PUSCH occasions within two CG periods of the first CG configuration.

In implementations a UCI can indicate CG transmission occasions from a set of possible unused CG transmission occasions, where the UCI indication is a start and length indicator value (SLIV)-like indication, e.g., indicating a starting symbol/slot within the time region and a length and/or number of consecutive symbols and/or slots within the time region. Parameters of a SLIV formula, for instance, can be configured by a network (e.g., via RRC signaling) and/or determined by a UE, e.g., based on the CG periodicity of the CG configuration carrying the UCI, the location of UCI within the CG configuration, the number of bits for the field indicating unused transmission occasions, etc.

In implementations the following is an example of SLIV-like indication with the starting symbol/CG transmission occasion S and length L [in number of symbols/CG transmission occasion]):
A reference point SO for starting symbol/CG transmission occasion S can be defined as: If a UE is configured with a RRC parameter that enables the starting symbol/CG transmission occasion S to be relative to the starting/ending symbol S0 of the UCI occasion; otherwise, the starting symbol S is relative to the start of the slot/CG transmission occasion using S0=0;
A number of consecutive symbols/CG transmission occasions L counting from the starting symbol/CG transmission occasion S allocated for the unused CG transmission occasion are determined from the start and length indicator SLIV.

In implementations if a UE is provided and/or configured (e.g., according to a configuration) with UCI for unused transmission occasion indication, the configuration can include: A set of serving cells by uo-ConfigurationPerServingCell (an RRC parameter), that includes a set of serving cell indexes and a corresponding set of locations for fields in the UCI by positionInUCI (an RRC parameter); or by positionInUCI-forSUL (e.g., an RRC parameter), for each serving cell for a supplementary uplink (SUL) carrier, such as where the serving cell is configured with a SUL carrier; and a set of CG configurations by uo-CGConfigs (e.g., an RRC parameter), that includes a set of CG configuration indexes and a corresponding set of locations for fields in the UCI by positionInUCI_CG, e.g., an RRC parameter. For instance, instead of having a field in UCI to indicate unused transmission occasions of a CG, the field could indicate unused occasions of a group of CGs. A set of CGs can be divided into multiple groups, and each group can have its own field in the UCI for indication of unused transmission occasions of that group.

Further, the configuration can include: an information payload size for UCI by uci-PayloadSize-ForUO (e.g., an RRC parameter), and/or an indication for time resources or occasions by timeDurationforUO, e.g., an RRC parameter.

In implementations including a serving cell and/or a CG configuration (and/or a group of CG configurations) having an associated field in UCI, for the field can be denoted by:
N_UO a number of bits provided by uo-PayloadSize (e.g., an RRC parameter);
T_UO a number of symbols, excluding symbols for reception of SS/PBCH blocks and/or DL symbols indicated by tdd-UL-DL-ConfigurationCommon and/or symbols corresponding to a measurement gap, from a number of symbols that is provided by timeDurationforUO (e.g., an RRC parameter), if the UCI transmission periodicity is ‘X’ slots and there are more than ‘Y’ potential UCI transmissions within the ‘X’ slots; or is equal to the UCI transmission periodicity (e.g., the periodicity of the first CG configuration), otherwise;
G_UO a number of partitions for the T_UO symbols/CG transmission occasions provided by timeGranularityforUO. For instance, if G_UO sets of bits from the most significant bit of the N_UO bits have a one-to-one mapping with G_UO groups of symbols/CG transmission occasions where each of the first G_UO−T_UO+└T_UO/G_UO┘·G_UO groups includes └T_UO/G_UO┘ symbols/CG transmission occasions and each of the remaining T_UO−└T_UO/G_UO┘·G_UO groups includes ┌T_UO/G_UO┐ symbols/CG transmission occasions. A UE determines a symbol duration with respect to a SCS configuration of an active UL BWP where the UE transmits the UCI.

In implementations an indication by the UCI for a serving cell can be applicable to a configured grant PUSCH transmission on the serving cell. Further, for a serving cell and/or a CG configuration, a UE can determine the first symbol of the T_UO symbols to be the first symbol that is after certain time (e.g. T'proc,2) from the end/beginning of UCI transmission, where T'proc,2 is obtained from Tproc,2 for PUSCH processing capability 2 assuming a value for d2,1 determined by a formula and an RRC parameter.

In implementations a UE is not expected to indicate an unused transmission occasion before a corresponding symbol that is certain time after the last symbol of the UCI. For instance, the certain time is Tproc,2 assuming that d2,1=0 after a last symbol of the UCI. In an implementation, the list of transmission occasions that can be indicated as unused starts from a transmission occasion that is at least a particular time after the UCI transmission.

The time region for unused transmission occasion indication for CG configurations of high priority/critical latency can be different than the time region of the CG configurations of low priority and/or non-critical latency.

Implementations also provide for number of occasions-based indications of unused occasions. Aspects of this discussion can apply to where a) a UCI indicates unused CG transmission occasions belonging to single CG configuration and b) a UCI indicates unused CG transmission occasions belonging to multiple CG configurations. In implementations, a UE can send a UCI to a network node, where the UCI indicates up to ‘X’ number of successive/consecutive/next transmission occasions (and/or ‘X’ groups of successive, consecutive, and/or next transmission occasions) from a reference time that are unused.

In implementations, each group of successive, consecutive, and/or next transmission occasions can include transmission occasions within a single period of CG configuration where the UCI is transmitted. For instance, an RRC parameter indicates whether the UCI indicates unused transmission occasions out of ‘X’ transmission occasions or unused groups of transmission occasions out of ‘X’ groups of transmission occasions; where each group can include transmission occasions of a single period of CG configuration where the UCI is transmitted. Alternatively, the group size can be configured, along with ‘X’.

In implementations a CG activation DCI or a MAC-CE (e.g., corresponding to the CG which carries the UCI) indicates ‘X’ and/or the group size, e.g., for transmission occasions. Further, ‘X’ may not be expected to be covering a fraction of CG transmission occasions of a CG configuration within a period of that CG configuration: e.g., when the number of CG transmission occasions within one period is less than a threshold and/or when the duration of transmission occasions within a period is smaller than a threshold. In an implementation, the UE is not expected to transmit a UCI indicating unused transmission occasions in a CG period or associated with a CG period when the number of CG transmission occasions within that period is smaller than a threshold, e.g., due to collision with DL signals or UL cancellation signals.

In scenarios where overlap of two CG configurations occurs, an unused CG occasion indication can apply to both CG configurations or only one CG configuration, e.g., an earlier starting or ending CG configuration, later starting or ending CG configuration, a CG configuration with longer resources/span in time domain and/or frequency domain within a CG period, a CG configuration that UCI is sent in, etc.

In implementations X can be configured per CG configuration. Further, an unused CG transmission occasion field in the UCI can include ‘Y’ bits; where Y<X. For instance, every floor(X/Y) number of CG transmission occasions constitutes a group of transmission occasions and can be associated with one bit of the unused CG transmission occasion field.

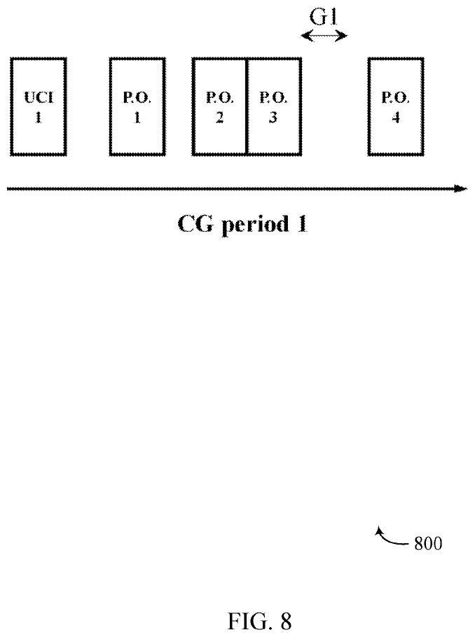

In implementations a UE is configured with a maximum gap ‘G1’ (e.g., in terms of number of symbols according to a reference SCS) between two successive transmission occasions referred to as TO1 and TO2); if the gap between TO1 and TO2 within the X number of successive transmission occasions is larger than ‘G1’, the UE may not be expected to indicate the remaining transmission occasions after TO1 to be unused, such as illustrated in FIG. 8.

In implementations a UE can be configured with a maximum gap value of G1 between two successive CG transmission occasions of the same CG configuration and G2 between two successive CG transmission occasions of different CG configurations. Instead of two successive occasions for each transmission occasion, the gap can be defined with respect to the first transmission occasion of the CG configuration within a period.

FIG. 8 illustrates an example implementation scenario 800 that supports indication for unused transmission occasions in accordance with aspects of the present disclosure. In the scenario 800 a gap between P.O. 3 and P.O. 4 is larger than the maximum gap G1, and thus an indication of unused occasions may not apply to P.O. 4. For instance, a gNB can assume that P.O. 3 is unused based on the indication and may not assume P.O. 4 is unused. Alternatively, the gap G1 can be defined from P.O. 1; for instance, if the gap between P.O. 1 and P.O. 4 is larger than a threshold, the gNB may not assume P.O. 4 is unused.

In implementations a UCI can indicate unused PUSCH occasions associated with CG configurations corresponding to UL transmissions of low priority, e.g., priority 0. Alternatively or additionally, a UE may not be expected to indicate unused PUSCH occasions of a CG configuration associated with high priority.

In implementations X is a number of nominal transmission occasions or alternatively, X is a number of actual transmission occasions. For instance, a network can configure and/or indicate for each CG configuration of the second set of CG configurations, whether actual or nominal occasions are to be considered in counting X number of successive, consecutive, and/or next transmission occasions. Further, a nominal PUSCH occasion can include one or more actual PUSCH occasions, where an actual PUSCH occasion can carry the initial transmission or repetition of a TB associated with the nominal PUSCH occasion. Further, one or more DL symbols in between UL symbols of a nominal PUSCH occasion can create one or more actual PUSCH occasions associated with the nominal PUSCH occasion. There may be no DL symbol in between UL symbols of an actual PUSCH occasion, e.g., the UL symbols of an actual PUSCH occasion are contiguous.

In implementations X may not indicate unused occasions which are farther than a threshold time T (e.g., in ms or in number of symbols and/or slots associated with a reference SCS or in number of PUSCH occasions or in number of CG periods) from a reference time point, e.g., UCI indicating the unused transmission occasions. T, for instance, can depend on PUSCH processing time, UE capability, indication and/or configuration by the network, etc.

In implementations, for CG configuration i (or alternatively, for logical channel configuration i), a UE may be configured with a time t_i that represents a maximum, minimum, and/or average time the UE may know in advance that the UE may have a packet for that CG and/or that logical channel configuration. For instance, the UE can indicate the unused CG occasions of CG configuration i based on the time UCI indicating the unused transmission occasions is sent and based on t_i. Alternatively, the UE can determine a time T_i associated with a CG based on a set of t_i's corresponding to logical channel configurations, which can be mapped to the CG. The UE can indicate unused CG occasions of CG configuration i based on the time UCI indicating the unused transmission occasions is sent and based on T_i. In an implementation, t_i and/or T_i can be in unit of ms, slots, symbols, CG periods, etc.

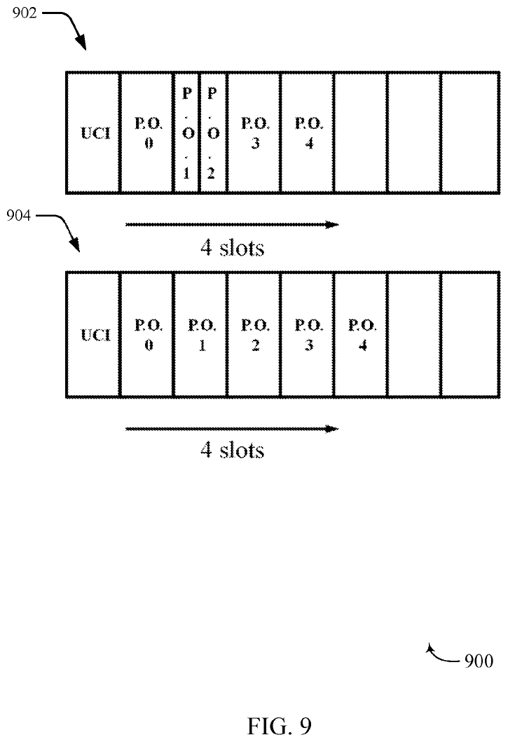

FIG. 9 illustrates an example implementation scenario 900 that supports indication for unused transmission occasions in accordance with aspects of the present disclosure. In the scenario 900 X=5; PUSCH Occasion (P.O.) 0 is used, PUSCH occasions 1-4 are unused. Accordingly, a UCI can indicate P.O. 1-4 as unused in the top figure at 902, and P.O. 1-3 can be indicated as unused in the bottom figure at 904, e.g., P.O. 4 is after 4 slots from the time UCI was sent; and hence is not to be indicated as unused. The top and bottom FIGS. 902, 904 can occur in a first time window (e.g., a first period of the CG configuration carrying the UCI) and a second time window (e.g., a second period of the CG configuration carrying the UCI), respectively. The slot carrying the UCI and P.O. 0 can belong to a first CG configuration. In the top FIG. 902: P.O. 1 and P.O. 2 can belong to a second CG configuration; P.O. 3 and P.O. 4 can belong to a third CG configuration. In the bottom FIG. 904: P.O. 1 and P.O. 2 can belong to a fourth CG configuration; P.O. 3 and P.O. 4 can belong to a fifth CG configuration.

In implementations transmission occasions of some of the CG configurations of the second set of CG configurations may overlap in some instances, e.g., in time domain. In such scenarios, a rule can be implemented to determine the unused transmission occasions indicated by the UCI. Some examples of such a rule include one of the following for scenarios where a first transmission occasion of CG configuration A overlaps (e.g., in time domain) with a second transmission occasion of CG configuration B: A UE can count, order, and/or sort transmission occasions according to their start times. If two transmission occasions start at the same time, the UE can count them as two separate transmission occasions; the first transmission occasion of the two transmission occasions can be the one that ends earlier or corresponding to a smaller or a larger CG index compared to that of the second transmission occasion. In implementations the UE is not expected to indicate that the first transmission occasion is unused.

In implementations a network may configure a UE (e.g., via RRC configuration) and/or indicate to a UE (e.g., via DCI or MAC-CE) to not count and/or skip CG transmission occasions of a fourth set of CG configurations in counting X number of successive, consecutive, and/or next transmission occasions, where the fourth set of CG configurations can be a subset of the first set of CG configurations.

In implementations a UCI can indicate CG transmission occasions from a set of possible unused CG transmission occasions, where the UCI indication is a SLIV-like indication, such as indicating a starting unused transmission occasion and a length and/or number of consecutive unused transmission occasions.

In implementations, the UE can indicate unused occasions of multiple CG configurations via a UCI in a period and/or time region if CG occasions of two CG configurations do not overlap in that period and/or time region. In another implementation, the UE is not expected to indicate a TO of a first CG configuration as unused if that TO overlaps (e.g., in time domain) with a TO of another CG configuration.

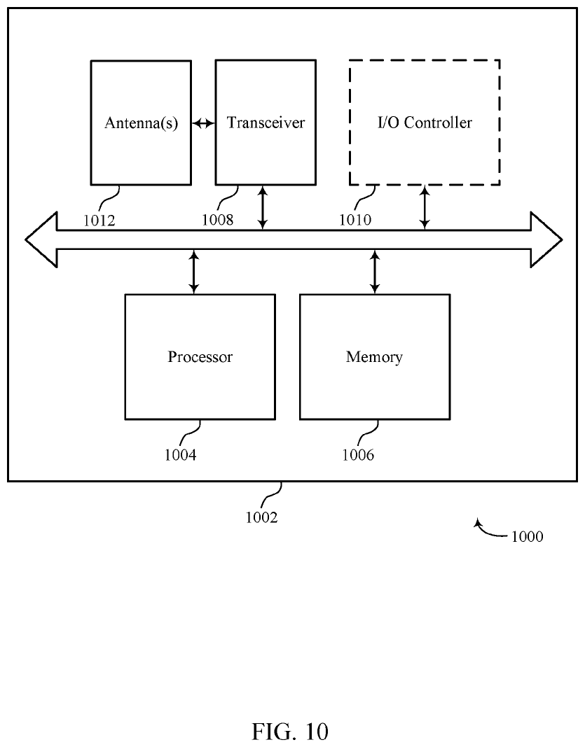

FIG. 10 illustrates an example of a block diagram 1000 of a device 1002 (e.g., an apparatus) that supports indication for unused transmission occasions in accordance with aspects of the present disclosure. The device 1002 may be an example of UE 104 as described herein. The device 1002 may support wireless communication with one or more network entities 102, UEs 104, or any combination thereof. The device 1002 may include components for bi-directional communications including components for transmitting and receiving communications, such as a processor 1004, a memory 1006, a transceiver 1008, and an I/O controller 1010. These components may be in electronic communication or otherwise coupled (e.g., operatively, communicatively, functionally, electronically, electrically) via one or more interfaces (e.g., buses).

The processor 1004, the memory 1006, the transceiver 1008, or various combinations thereof or various components thereof may be examples of means for performing various aspects of the present disclosure as described herein. For example, the processor 1004, the memory 1006, the transceiver 1008, or various combinations or components thereof may support a method for performing one or more of the operations described herein.

In some implementations, the processor 1004, the memory 1006, the transceiver 1008, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 1004 and the memory 1006 coupled with the processor 1004 may be configured to perform one or more of the functions described herein (e.g., executing, by the processor 1004, instructions stored in the memory 1006). In the context of UE 104, for example, the transceiver 1008 and the processor coupled 1004 coupled to the transceiver 1008 are configured to cause the UE 104 to perform the various described operations and/or combinations thereof.

For example, the processor 1004 and/or the transceiver 1008 may support wireless communication at the device 1002 in accordance with examples as disclosed herein. For instance, the processor 1004 and/or the transceiver 1008 may be configured as and/or otherwise support a means to receive a first set of CG configurations including a second set of CG configurations that are a subset of the first set of CG configurations, and a third set of CG configurations that are a subset of the second set of CG configurations; generate an indication of one or more unused transmission occasions of a list of transmission occasions, the transmission occasions of the list of transmission occasions occurring within a window of time and being ordered in an order of start time of the transmission occasions, and the one or more unused transmission occasions being associated with the second set of CG configurations; and transmit, in a transmission occasion of the third set of CG configurations, the indication of the one or more unused transmission occasions.

Further, in some implementations, the second set of CG configurations includes at least two CG configurations; a CG configuration of the first set of CG configurations enables UL transmissions in periodic UL resources with a configured periodicity associated with the CG configuration, and an UL resource of the UL resources belongs to a period of a plurality of periods; the processor is configured to cause the apparatus to identify, in the indication of the one or more unused transmission occasions, the one or more unused transmission occasions as one or more transmission occasions in which no CG-PUSCH transmission is to occur; the processor is configured to cause the apparatus to transmit the indication of the one or more unused transmission occasions via UCI; the processor is configured to cause the apparatus to transmit the UCI in a transmission occasion, and the transmission occasion is associated with a first CG configuration of the third set of CG configurations; the processor is configured to cause the apparatus to determine a duration of the window of time based at least in part on at least one of a higher layer configuration message, a periodicity of the first CG configuration, a time location of the UCI, a frequency location of the UCI, an end of the UCI, or a number of bits configured for indication of the one or more unused transmission occasions in the UCI.

Further, in some implementations, the processor is configured to cause the apparatus to determine the second set of CG configurations based at least in part on an indication indicating CG configuration indices of a fourth set of CG configurations, where the fourth set of CG configurations includes at least CG configurations of the second set of CG configurations excluding the first CG configuration; the processor is configured to cause the apparatus to receive DCI activating the first CG configuration, and transmit the UCI based at least in part on the DCI indicating that the UCI is permitted to be sent in a transmission occasion associated with the first CG configuration; the DCI activating the first CG configuration indicates at least one of a number of bits in the UCI for indication of the one or more unused transmission occasions and a duration of the window of time; the processor is configured to cause the apparatus to determine a duration of the window of time based at least in part on higher layer signaling; the processor is configured to cause the apparatus to receive an indication indicating a fourth set of CG configurations, and determine the second set of CG configurations by excluding the fourth set of CG configurations from the first set of CG configurations.

Further, in some implementations, the processor is configured to cause the apparatus to transmit the indication of the one more unused transmission occasions via UCI, and to generate the UCI to indicate, for the one or more unused transmission occasions: a first set of unused transmission occasions associated with a first group of CG configurations in a first field in the UCI; and a second set of unused transmission occasions associated with a second group of CG configurations in a second field in the UCI, where a position of the first field and a position of the second field within the UCI are configured, and the first group of CG configurations and the second group of CG configurations do not share a common CG configuration; the processor is configured to cause the apparatus to determine the list of transmission occasions in an order of a respective start time of each transmission occasion within the window of time; the processor is configured to cause the apparatus to determine the list of transmission occasions such that a first transmission occasion of the list of transmission occasions has an earliest start time of the transmission occasions, and subsequent transmission occasions after the first transmission occasion are identified in the list of transmission occasions in a corresponding temporal order.

Further, in some implementations, if a first transmission occasion and a second transmission occasion have a same start time, the processor is configured to cause the apparatus to determine the first transmission occasion as earlier than the second transmission occasion in the list of transmission occasions based at least in part on one or more of: the first transmission occasion ending earlier than the second transmission occasion; the first transmission occasion including fewer resource elements than the second transmission occasion; the first transmission occasion being associated with a higher priority than the second transmission occasion; the first transmission occasion being associated with a lower latency than the second transmission occasion; the first transmission occasion starting in a frequency domain earlier than the second transmission occasion; or the first transmission occasion being associated with a smaller CG configuration index than the second transmission occasion.

The processor 1004 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 1004 may be configured to operate a memory array using a memory controller. In some other implementations, a memory controller may be integrated into the processor 1004. The processor 1004 may be configured to execute computer-readable instructions stored in a memory (e.g., the memory 1006) to cause the device 1002 to perform various functions of the present disclosure.

The memory 1006 may include random access memory (RAM) and read-only memory (ROM). The memory 1006 may store computer-readable, computer-executable code including instructions that, when executed by the processor 1004 cause the device 1002 to perform various functions described herein. The code may be stored in a non-transitory computer-readable medium such as system memory or another type of memory. In some implementations, the code may not be directly executable by the processor 1004 but may cause a computer (e.g., when compiled and executed) to perform functions described herein. In some implementations, the memory 1006 may include, among other things, a basic I/O system (BIOS) which may control basic hardware or software operation such as the interaction with peripheral components or devices.

The I/O controller 1010 may manage input and output signals for the device 1002. The I/O controller 1010 may also manage peripherals not integrated into the device M02. In some implementations, the I/O controller 1010 may represent a physical connection or port to an external peripheral. In some implementations, the I/O controller 1010 may utilize an operating system such as iOS®, ANDROID®, MS-DOS®, MS-WINDOWS®, OS/2®, UNIX®, LINUX®, or another known operating system. In some implementations, the I/O controller 1010 may be implemented as part of a processor, such as the processor M08. In some implementations, a user may interact with the device 1002 via the I/O controller 1010 or via hardware components controlled by the I/O controller 1010.

In some implementations, the device 1002 may include a single antenna 1012. However, in some other implementations, the device 1002 may have more than one antenna 1012 (e.g., multiple antennas), including multiple antenna panels or antenna arrays, which may be capable of concurrently transmitting or receiving multiple wireless transmissions. The transceiver 1008 may communicate bi-directionally, via the one or more antennas 1012, wired, or wireless links as described herein. For example, the transceiver 1008 may represent a wireless transceiver and may communicate bi-directionally with another wireless transceiver. The transceiver 1008 may also include a modem to modulate the packets, to provide the modulated packets to one or more antennas 1012 for transmission, and to demodulate packets received from the one or more antennas 1012.

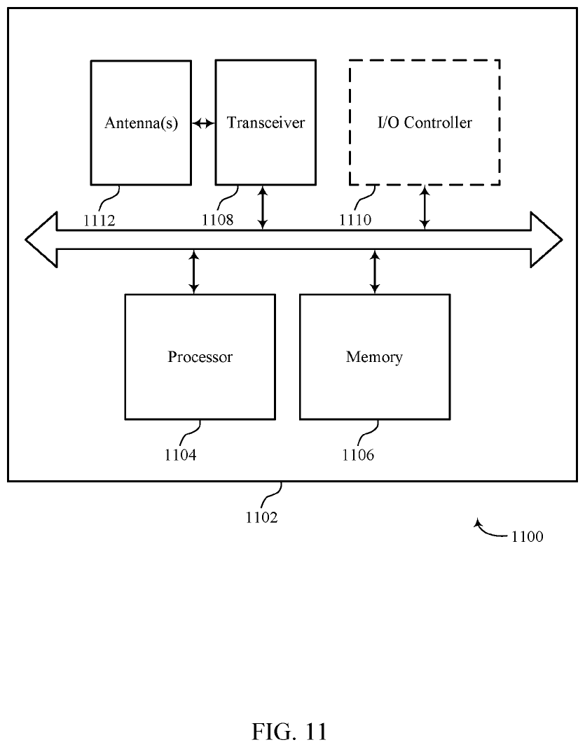

FIG. 11 illustrates an example of a block diagram 1100 of a device 1102 (e.g., an apparatus) that supports indication for unused transmission occasions in accordance with aspects of the present disclosure. The device 1102 may be an example of a network entity 102 as described herein. The device 1102 may support wireless communication with one or more network entities 102, UEs 104, or any combination thereof. The device 1102 may include components for bi-directional communications including components for transmitting and receiving communications, such as a processor 1104, a memory 1106, a transceiver 1108, and an I/O controller 1110. These components may be in electronic communication or otherwise coupled (e.g., operatively, communicatively, functionally, electronically, electrically) via one or more interfaces (e.g., buses).

The processor 1104, the memory 1106, the transceiver 1108, or various combinations thereof or various components thereof may be examples of means for performing various aspects of the present disclosure as described herein. For example, the processor 1104, the memory 1106, the transceiver 1108, or various combinations or components thereof may support a method for performing one or more of the operations described herein.

In some implementations, the processor 1104, the memory 1106, the transceiver 1108, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 1104 and the memory 1106 coupled with the processor 1104 may be configured to perform one or more of the functions described herein (e.g., executing, by the processor 1104, instructions stored in the memory 1106). In the context of network entity 102, for example, the transceiver 1108 and the processor 1104 coupled to the transceiver 1108 are configured to cause the network entity 102 to perform the various described operations and/or combinations thereof.

For example, the processor 1104 and/or the transceiver 1108 may support wireless communication at the device 1102 in accordance with examples as disclosed herein. For instance, the processor 1104 and/or the transceiver 1108 may be configured as or otherwise support a means to generate a CG indication including a first set of CG configurations, a second set of CG configurations that are a subset of the first set of CG configurations, and a third set of CG configurations that are subset of the second set of CG configurations; transmit the CG indication; and receive, in a transmission occasion of the third set of CG configurations, an indication of one or more unused transmission occasions of a list of transmission occasions, the transmission occasions of the list of transmission occasions occurring within a window of time and being ordered in an order of start time of transmission occasions.

Further, in some implementations, a CG configuration of the first set of CG configurations enables UL transmissions in periodic UL resources with a configured periodicity associated with the CG configuration, and an UL resource of the UL resources belongs to a period of a plurality of periods; the processor is configured to cause the apparatus to receive the indication of the one or more unused transmission occasions via UCI; the processor is configured to cause the apparatus to determine the one or more unused transmission occasions from the indication of the one or more unused transmission occasions based at least in part on the list of transmission occasions and the UCI; the processor is configured to cause the apparatus to indicate a duration of the window of time via higher layer signaling; the processor is configured to cause the apparatus to transmit an indication of a fourth set of CG configurations for which the apparatus does not expect to receive the indication of the one or more unused transmission occasions.

Further, in some implementations, the processor is configured to cause the apparatus to generate the list of transmission occasions in an order of a respective start time of each transmission occasion within the window of time; if a first transmission occasion and a second transmission occasion have a same start time, the processor is configured to cause the apparatus to indicate the first transmission occasion as earlier than the second transmission occasion in the list of transmission occasions based at least in part on one or more of: the first transmission occasion ending earlier than the second transmission occasion; the first transmission occasion including fewer resource elements than the second transmission occasion; the first transmission occasion being associated with a higher priority than the second transmission occasion; the first transmission occasion being associated with a lower latency than the second transmission occasion; the first transmission occasion starting earlier in a frequency domain earlier than the second transmission occasion; or the first transmission occasion being associated with a smaller CG configuration index than the second transmission occasion.

The processor 1104 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 1104 may be configured to operate a memory array using a memory controller. In some other implementations, a memory controller may be integrated into the processor 1104. The processor 1104 may be configured to execute computer-readable instructions stored in a memory (e.g., the memory 1106) to cause the device 1102 to perform various functions of the present disclosure.

The memory 1106 may include random access memory (RAM) and read-only memory (ROM). The memory 1106 may store computer-readable, computer-executable code including instructions that, when executed by the processor 1104 cause the device 1102 to perform various functions described herein. The code may be stored in a non-transitory computer-readable medium such as system memory or another type of memory. In some implementations, the code may not be directly executable by the processor 1104 but may cause a computer (e.g., when compiled and executed) to perform functions described herein. In some implementations, the memory 1106 may include, among other things, a basic I/O system (BIOS) which may control basic hardware or software operation such as the interaction with peripheral components or devices.

The I/O controller 1110 may manage input and output signals for the device 1102. The I/O controller 1110 may also manage peripherals not integrated into the device M02. In some implementations, the I/O controller 1110 may represent a physical connection or port to an external peripheral. In some implementations, the I/O controller 1110 may utilize an operating system such as iOS®, ANDROID®, MS-DOS®, MS-WINDOWS®, OS/2®, UNIX®, LINUX®, or another known operating system. In some implementations, the I/O controller 1110 may be implemented as part of a processor, such as the processor M06. In some implementations, a user may interact with the device 1102 via the I/O controller 1110 or via hardware components controlled by the I/O controller 1110.

In some implementations, the device 1102 may include a single antenna 1112. However, in some other implementations, the device 1102 may have more than one antenna 1112 (e.g., multiple antennas), including multiple antenna panels or antenna arrays, which may be capable of concurrently transmitting or receiving multiple wireless transmissions. The transceiver 1108 may communicate bi-directionally, via the one or more antennas 1112, wired, or wireless links as described herein. For example, the transceiver 1108 may represent a wireless transceiver and may communicate bi-directionally with another wireless transceiver. The transceiver 1108 may also include a modem to modulate the packets, to provide the modulated packets to one or more antennas 1112 for transmission, and to demodulate packets received from the one or more antennas 1112.

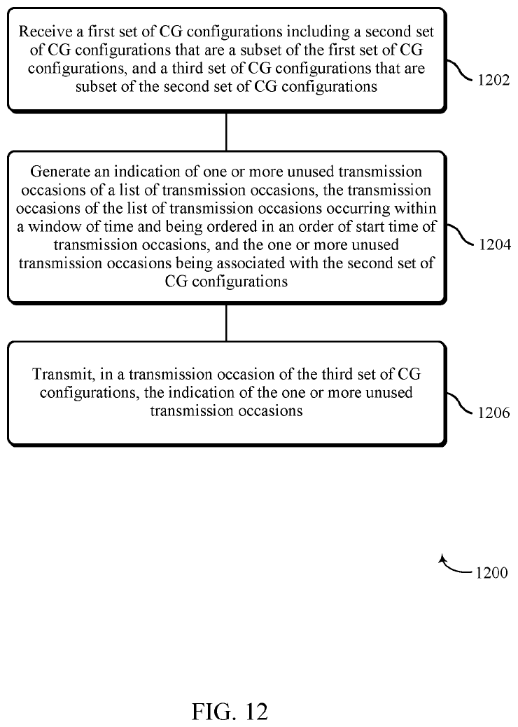

FIG. 12 illustrates a flowchart of a method 1200 that supports indication for unused transmission occasions in accordance with aspects of the present disclosure. The operations of the method 1200 may be implemented by a device or its components as described herein. For example, the operations of the method 1200 may be performed by a UE 104 as described with reference to FIGS. 1 through 11. In some implementations, the device may execute a set of instructions to control the function elements of the device to perform the described functions. Additionally, or alternatively, the device may perform aspects of the described functions using special-purpose hardware.

At 1202, the method may include receiving a first set of CG configurations including a second set of CG configurations that are a subset of the first set of CG configurations, and a third set of CG configurations that are subset of the second set of CG configurations. The operations of 1202 may be performed in accordance with examples as described herein. In some implementations, aspects of the operations of 1202 may be performed by a device as described with reference to FIG. 1.

At 1204, the method may include generating an indication of one or more unused transmission occasions of a list of transmission occasions, the transmission occasions of the list of transmission occasions occurring within a window of time and being ordered in an order of start time of transmission occasions, and the one or more unused transmission occasions being associated with the second set of CG configurations. The operations of 1204 may be performed in accordance with examples as described herein. In some implementations, aspects of the operations of 1204 may be performed by a device as described with reference to FIG. 1.

At 1206, the method may include transmitting, in a transmission occasion of the third set of CG configurations, the indication of the one or more unused transmission occasions. The operations of 1206 may be performed in accordance with examples as described herein. In some implementations, aspects of the operations of 1206 may be performed by a device as described with reference to FIG. 1.

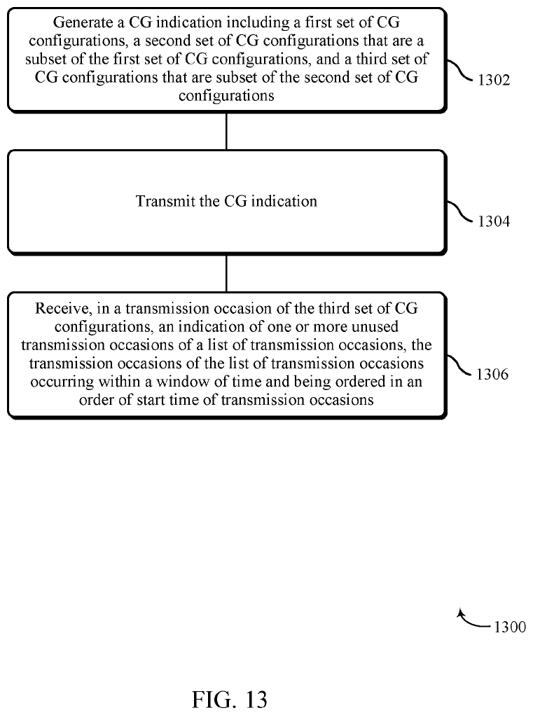

FIG. 13 illustrates a flowchart of a method 1300 that supports indication for unused transmission occasions in accordance with aspects of the present disclosure. The operations of the method 1300 may be implemented by a device or its components as described herein. For example, the operations of the method 1300 may be performed by a network entity 102 as described with reference to FIGS. 1 through 11. In some implementations, the device may execute a set of instructions to control the function elements of the device to perform the described functions. Additionally, or alternatively, the device may perform aspects of the described functions using special-purpose hardware.

At 1302, the method may include generating a CG indication including a first set of CG configurations, a second set of CG configurations that are a subset of the first set of CG configurations, and a third set of CG configurations that are subset of the second set of CG configurations. The operations of 1302 may be performed in accordance with examples as described herein. In some implementations, aspects of the operations of 1302 may be performed by a device as described with reference to FIG. 1.

At 1304, the method may include transmitting the CG indication. The operations of 1304 may be performed in accordance with examples as described herein. In some implementations, aspects of the operations of 1304 may be performed by a device as described with reference to FIG. 1.

At 1306, the method may include receiving, in a transmission occasion of the third set of CG configurations, an indication of one or more unused transmission occasions of a list of transmission occasions, the transmission occasions of the list of transmission occasions occurring within a window of time and being ordered in an order of start time of transmission occasions. The operations of 1306 may be performed in accordance with examples as described herein. In some implementations, aspects of the operations of 1306 may be performed by a device as described with reference to FIG. 1.

It should be noted that the methods described herein describes possible implementations, and that the operations and the steps may be rearranged or otherwise modified and that other implementations are possible. Further, aspects from two or more of the methods may be combined.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (e.g., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The terms “transmitting,” “receiving,” or “communicating,” when referring to a network entity, may refer to any portion of a network entity (e.g., a base station, a CU, a DU, a RU) of a RAN communicating with another device (e.g., directly or via one or more other network entities).

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1-20. (canceled)

21. A user equipment (UE) for wireless communication, comprising:
at least one memory; and
at least one processor coupled with the at least one memory and operable to cause the UE to:
receive a configuration indicating a number of bits for indication of unused configured grant (CG) transmission occasions; and
transmit, based at least in part on the configuration, an indication of one or more unused CG transmission occasions, wherein the one or more unused CG transmission occasions are indicated in order of start time.

22. The UE of claim 21, wherein the one or more unused CG transmission occasions comprise one or more unused CG physical uplink shared channel (PUSCH) transmission occasions.

23. The UE of claim 21, wherein the one or more unused CG transmission occasions are determined based at least in part on a one-to-one mapping of the one or more unused CG transmission occasions in the order of start time.

24. The UE of claim 21, wherein the indication of one or more unused CG transmission occasions does not include one or more CG transmission occasions that collide with one or more downlink (DL) symbols.

25. The UE of claim 24, wherein the one or more DL symbols are indicated by tdd-UL-DL-ConfigurationCommon.

26. The UE of claim 24, wherein the one or more DL symbols comprise one or more DL symbols for reception of synchronization signal/physical broadcast channel (SS/PBCH) blocks.

27. The UE of claim 21, wherein the indication of one or more unused CG transmission occasions is transmitted via uplink control information (UCI).

28. A method performed by a user equipment (UE), the method comprising:
receiving a configuration indicating a number of bits for indication of unused configured grant (CG) transmission occasions; and
transmitting, based at least in part on the configuration, an indication of one or more unused CG transmission occasions, wherein the one or more unused CG transmission occasions are indicated in order of start time.

29. The method of claim 28, wherein the one or more unused CG transmission occasions comprise one or more unused CG physical uplink shared channel (PUSCH) transmission occasions.

30. The method of claim 28, wherein the one or more unused CG transmission occasions are determined based at least in part on a one-to-one mapping of the one or more unused CG transmission occasions in the order of start time.

31. The method of claim 28, wherein the indication of one or more unused CG transmission occasions does not include one or more CG transmission occasions that collide with one or more downlink (DL) symbols.

32. The method of claim 31, wherein the one or more DL symbols are indicated by tdd-UL-DL-ConfigurationCommon.

33. The method of claim 31, wherein the one or more DL symbols comprise one or more DL symbols for reception of synchronization signal/physical broadcast channel (SS/PBCH) blocks.

34. The method of claim 28, wherein the indication of one or more unused CG transmission occasions is transmitted via uplink control information (UCI).

35. A network entity for wireless communication, comprising:
at least one memory; and
at least one processor coupled with the at least one memory and operable to cause the network entity to:
transmit a configuration indicating a number of bits for indication of unused configured grant (CG) transmission occasions; and
receive, based at least in part on the configuration, an indication of one or more unused CG transmission occasions, wherein the one or more unused CG transmission occasions are indicated in order of start time.

36. The network entity of claim 35, wherein the one or more unused CG transmission occasions comprise one or more unused CG physical uplink shared channel (PUSCH) transmission occasions.

37. The network entity of claim 35, wherein the indication of one or more unused CG transmission occasions does not include one or more CG transmission occasions that collide with one or more downlink (DL) symbols.

38. The network entity of claim 37, wherein the one or more DL symbols are indicated by tdd-UL-DL-ConfigurationCommon.

39. The network entity of claim 35, wherein the indication of one or more unused CG transmission occasions is received via uplink control information (UCI).

40. A method performed by a network entity, the method comprising:
transmitting a configuration indicating a number of bits for indication of unused configured grant (CG) transmission occasions; and
receiving, based at least in part on the configuration, an indication of one or more unused CG transmission occasions, wherein the one or more unused CG transmission occasions are indicated in order of start time.
